(19) United States
(12) Patent Application Publication
(10) Pub. No.: US 2014/0220912 A1
(43) Pub. Date: Aug. 7, 2014

(54) Mobile Communication Device

(71) Applicant: Wistron Corporation, New Taipei City (TW)

(72) Inventors: Shih-Ming Chuang, New Taipei City (TW); Wen-Yi Tsai, New Taipei City (TW); Pei-Cheng Hu, New Taipei City (TW)

(73) Assignee: Wistron Corporation, New Taipei City (TW)

(21) Appl. No.: 14/055,896

(22) Filed: Oct. 17, 2013

(30) Foreign Application Priority Data
Feb. 4, 2013 (TW) 102104236

(51) Int. Cl. H04B 1/38

(52) U.S. Cl. CPC H04B 1/3827
USPC 455/90.2

(57) ABSTRACT

A mobile communication device including a main board, a flexible printed circuit board (FPCB) and a transmission line. The main board includes a central process unit (CPU) disposed on the main board for outputting and receiving a control signal, and a wireless transmitter disposed on the main board and coupled to the CPU for modulating and demodulating a wireless signal. The FPCB is coupled to the CPU to operate as an antenna for transmitting the control signal and radiating and receiving the wireless signal. The FPCB includes a transmission unit coupled to the CPU for transmitting the control signal, a radiation unit for radiating and receiving the wireless signal, and a feed point formed on the radiation unit for feeding the wireless signal to the radiation unit. The transmission line is coupled between the feed point and the wireless transmitter for transmitting the wireless signal.

### BACKGROUND OF THE INVENTION

1. Field of the Invention

The present invention relates to a mobile communication device, and more particularly, to a mobile communication device utilizing a flexible printed circuit board as an antenna to radiate and receive wireless signals.

2. Description of the Prior Art

Because of the prosperous development of wireless communications in recent years, more and more information is transmitted through wireless networks and thus demands for wireless communications has increased. Moreover, advances in laptop, pad computer and smart phone technologies also increase requirements for products of compact size, and the following reduced antenna size. Therefore, how to effectively make use of an interior space and a circuit design of a mobile communication to integrate an antenna into the mobile communication device has become a topic in the industry.

### SUMMARY OF THE INVENTION

It is therefore an objective of the present invention to provide a mobile communication device utilizing a flexible printed circuit board as an antenna to radiate and receive wireless signal to effectively make use of the interior space and the circuit design of the mobile communication device.

The present invention discloses a mobile communication device including a main board, a flexible printed circuit board (FPCB) and a transmission line. The main board includes a central process unit (CPU) disposed on the main board for outputting and receiving a control signal, and a wireless transmitter disposed on the main board and coupled to the CPU for modulating and demodulating a wireless signal to the CPU to perform signal process. The FPCB is coupled to the CPU to operate as an antenna for transmitting the control signal and radiating and receiving the wireless signal. The FPCB includes a transmission unit coupled to the CPU for transmitting the control signal, a radiation unit for radiating and receiving the wireless signal, and a feed point formed on the radiation unit for feeding the wireless signal to the radiation unit. The transmission line is coupled between the feed point and the wireless transmitter for transmitting the wireless signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a mobile communication device according to an embodiment of the present invention.

FIG. 2A and FIG. 2B are circuit structural diagrams of a side view and a top view of the mobile communication device shown in FIG. 1, respectively.

FIG. 2C is a partially enlarged diagram of the mobile communication device shown in FIG. 1.

FIG. 3 is a schematic diagram of a flexible printed circuit board according to an embodiment of the present invention.

FIG. 4A to FIG. 4C are schematic diagrams illustrating radiation patterns of the mobile communication device shown in FIG. 1 at operating frequencies 1.57 GHz, 1.6 GHz and 1.65 GHz, respectively.

### DETAILED DESCRIPTION

A flexible printed circuit board (hereafter called FPCB) has advantages such as being thin as a paper to save space, flexibility and customized production to be widely used in electronic and mobile communication devices to transmit signals between circuits or elements. Therefore, the present invention designs an antenna on the FPCB to save cost and time for separately producing the transmission line and the antenna and may effectively make use of the interior space and the circuit design of the mobile communication as well.

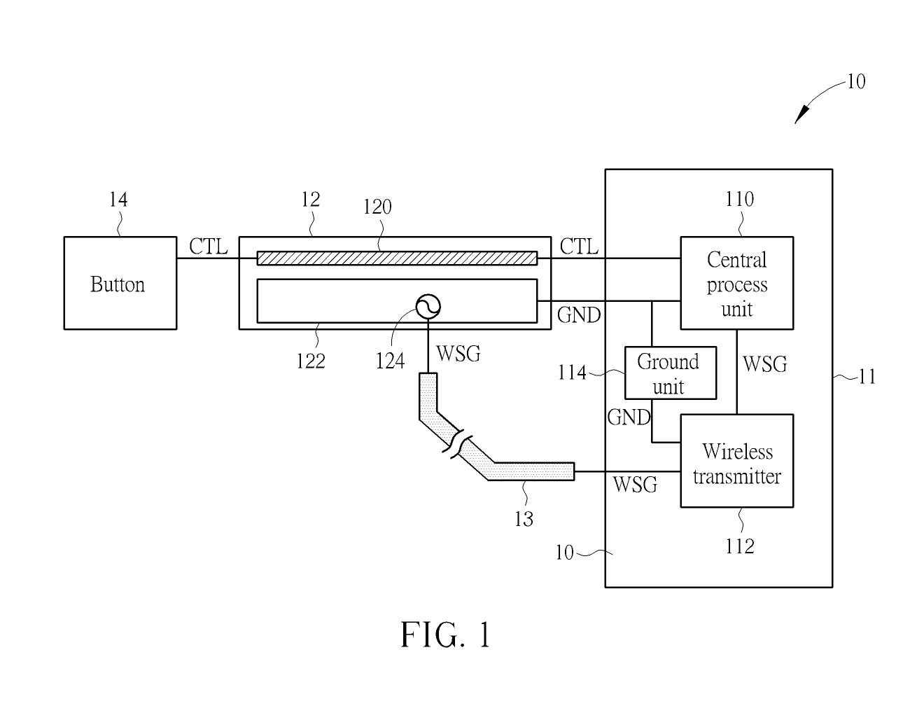

Please refer to FIG. 1, which is a functional block diagram of a mobile communication device 10 according to an embodiment of the present invention. The mobile communication device 10 includes a main board 11, an FPCB 12, a transmission line 13 and a button 14. The main board 11 includes a central process unit (hereafter CPU) 110, a wireless transmitter 112 and a ground unit 114. The CPU 110 may be disposed on the main board 11 for outputting and receiving a control signal CTL. The wireless transmitter 112 may be disposed on the main board 11 and coupled to the CPU 110 for modulating and demodulating a wireless signal WSG, such that the CPU 110 may perform signal processing on the wireless signal WSG. The ground unit 114 may be formed on the main board 11 and coupled to the CPU 110 and the wireless transmitter 112 for providing a system ground GND. The FPCB 12 may be coupled to the CPU 110 for transmitting the control signal CTL and for radiating and receiving the wireless signal WSG to operate as an antenna. The FPCB 12 includes a transmission unit 120, a radiation unit 122 and a feed point 124. The transmission unit 120 may be coupled to the CPU 110 for transmitting the control signal CTL. The radiation unit 122 may be used for radiating and receiving the wireless signal WSG. In other words, in the mobile communication device 10, the radiation unit 122 may radiate the wireless signal WSG into the air during signal transmission, and the radiation unit 122 may induce the wireless signal WSG from the air during signal reception. The feed point 124 may be formed on the radiation unit 122 for feeding the wireless signal WSG into the radiation unit 122. The transmission line 13 may be coupled between the feed point 124 and the wireless transmitter 112 for transmitting the wireless signal WSG.

Noticeably, the radiation unit 122 of the FPCB 12 may be coupled to the ground unit 114 of the main board 11, i.e. the system ground GND, and thus the FPCB 12 may be regarded as a Planar Inverted-F Antenna (PIFA) for radiating and receiving the wireless signal WSG.

In short, the transmission unit 120 and the radiation unit 122 are formed on the FPCB 12 to respectively transmit the control signal CTL and to radiate and receive the wireless signal WSG, in such a structure, the FPCB 12 may not only be a transmission line but also an antenna.

As a result, a transmission line, i.e. the transmission unit 120, for transmitting the control signal CTL and an antenna, i.e. the radiation unit 122, for and radiating and receiving the wireless signal WSG may be integrated into a single part, i.e. the FPCB 12 to save cost and time for separately producing the transmission line and the antenna.

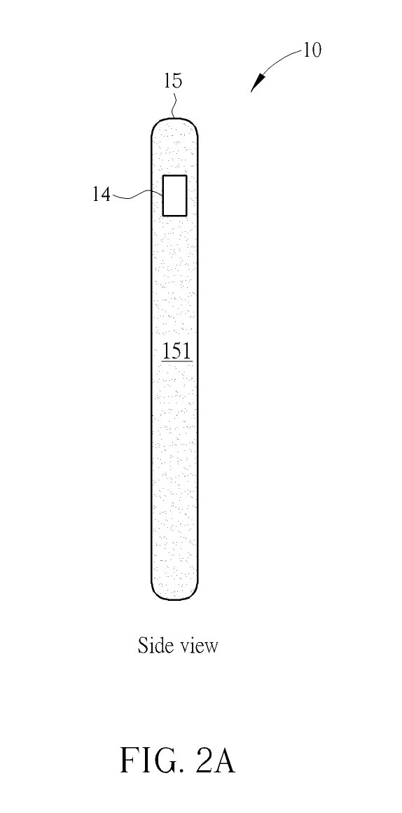

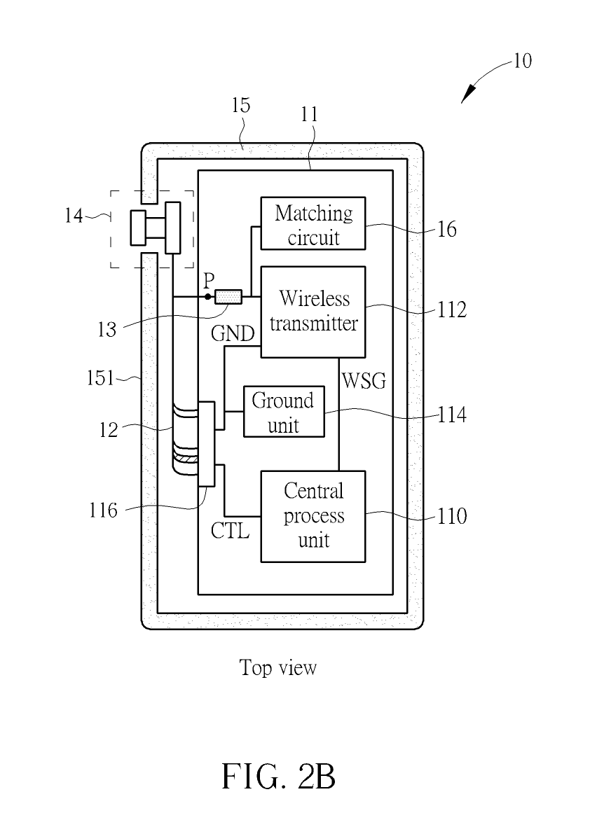

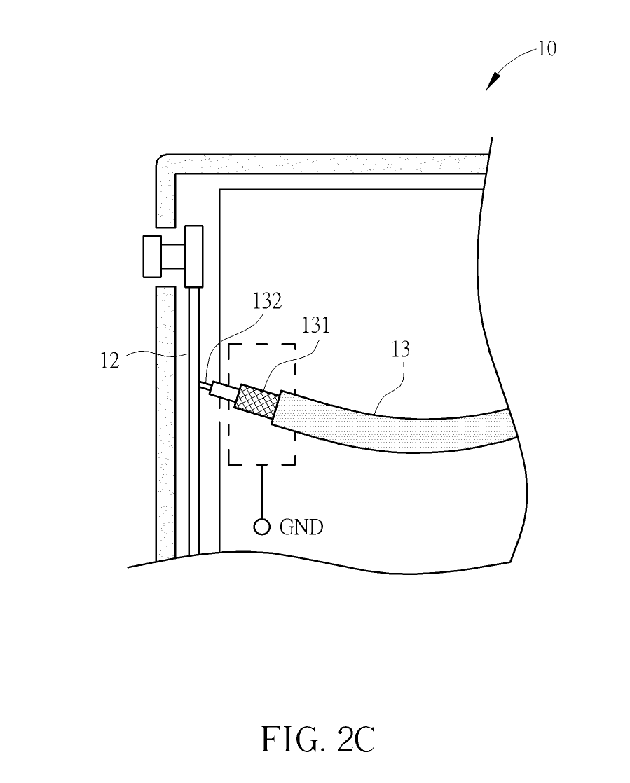

Please refer to FIG. 2A to FIG. 2C for a specific circuit structure of the mobile communication device 10. FIG. 2A and FIG. 2B are circuit structural diagrams illustrating a side view and a top view of the mobile communication device 10 according to an embodiment of the present invention, respectively. FIG. 2C is a partially enlarged schematic diagram of the mobile communication device 10. The mobile communication device 10 further includes a housing 15 for covering elements comprised in the mobile communication device 10. As shown in FIG. 2A, the button 14 may be formed on a surface 151 of the housing 15, the button 14 may generate the control signal CTL via being pressed by an external force, or the button 14 may adjust the control signal CTL via being slid by the external force. For example, the button 14 in the embodiment is illustrated with a compressive button, a user may press the button 14 to turn on or turn off a display (not shown in FIG. 2A to FIG. 2C) of the mobile communication device 10.

As shown in FIG. 2B, a terminal of the FPCB 12 coupled to the button 14 may be disposed in parallel to the surface 151, and a terminal of the FPCB 12 coupled to the main board 11 may be bent such that part of the FPCB 12 may be disposed in parallel to the main board 11. The FPCB 12 may coupled to the main board 11 by a connector 116, such that the connector 116 may connect the control signal CTL to the CPU 110 and connect the system ground GND to the ground unit 114.

As shown in FIG. 2C, the transmission line 13 is preferably a co-axial cable to improve an insertion loss and a return loss of the wireless signal WSG since the co-axial cable has a better transmission characteristic. The transmission line 13 includes a braided shield 131 and a center core 132. The braided shield 131 may be soldered on the main board 11 to coupled to the system ground GND, the center core 132 may be soldered with the feed point 124 (not shown in FIG. 2C) to feed the wireless signal WSG into the radiation unit 122 (not shown in FIG. 2C). In such a structure, the FPCB 12 may operate as an antenna for radiating and receiving the wireless signal WSG.

Besides, the mobile communication device 10 may further include a matching circuit 16 disposed on the main board 11 and coupled between the transmission line 13 and the wireless transmitter 112. The matching circuit 16 may be used for matching impedances between the transmission line 13 and the wireless transmitter 112. However, locations where the matching circuit 16 is disposed are not limited, the matching circuit 16 may be disposed and coupled between the transmission line 13 and feed point 124, e.g. a position P shown in FIG. 2B, thus, the matching circuit 16 may be used for matching impedances between the transmission line 13 and feed point 124.

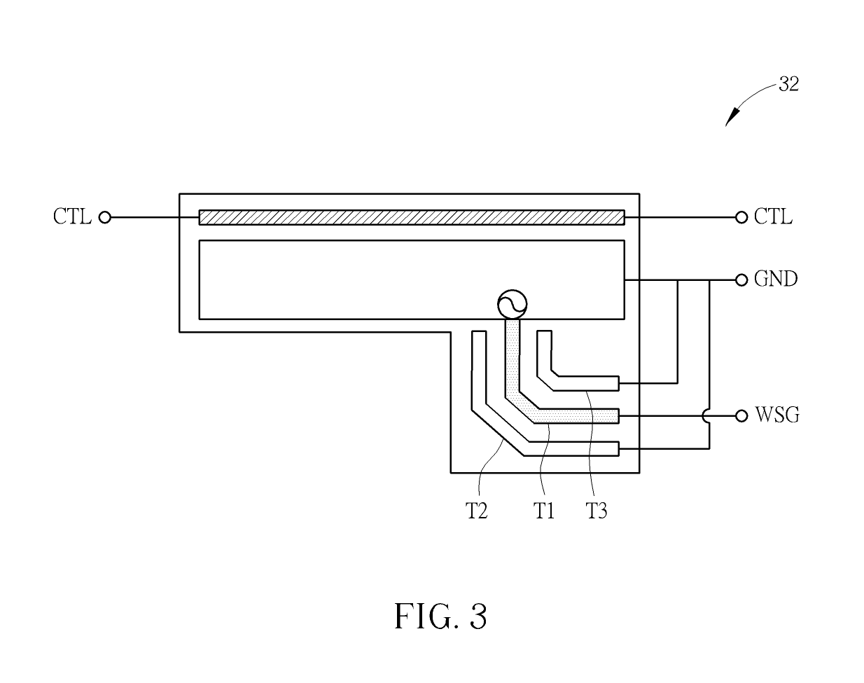

On the other hand, the transmission line 13 is not limited to a co-axial cable; the transmission line 13 may be a metal wire, a pogo pin, a spring, a printed trace of the FPCB 12 or a printed trace of the main board 11. For example, please refer to FIG. 3, which is a schematic diagram of an FPCB 32 according to an embodiment of the present invention. Printed traces T1, T2 and T3 may be formed on the FPCB 32 to operate as a transmission line. The printed trace T1 may be used for transmitting the wireless signal WSG, and the printed traces T2 and T3 may be formed on two sides of the printed trace T1 and coupled to the system ground GND to be ground references of the printed trace T1 so as to improve the insertion loss and the return loss of the wireless signal WSG. In such a structure, a number of parts for assembling the mobile communication device 10 may be decreased, which may speedup or decrease a difficulty for production.

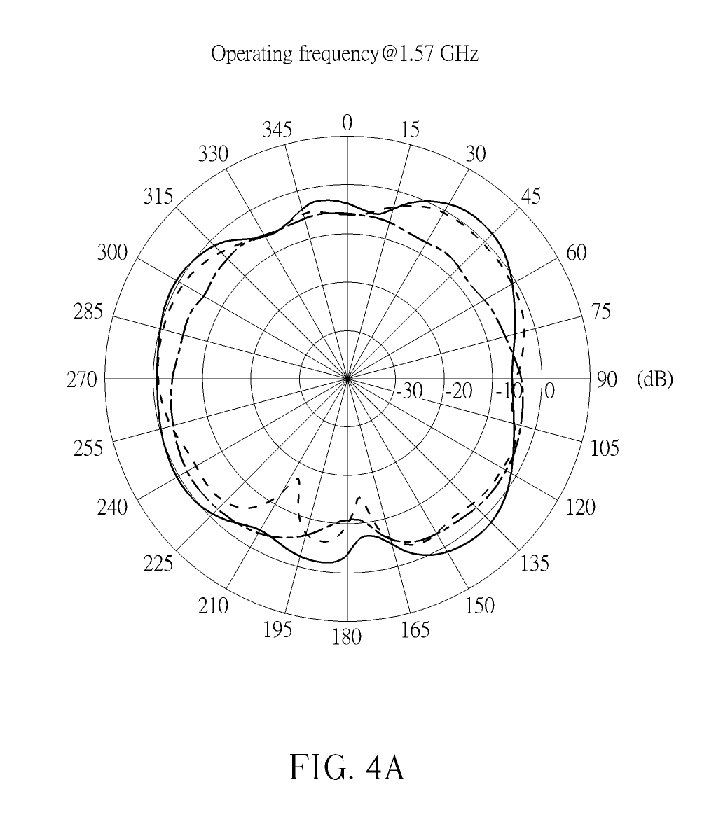

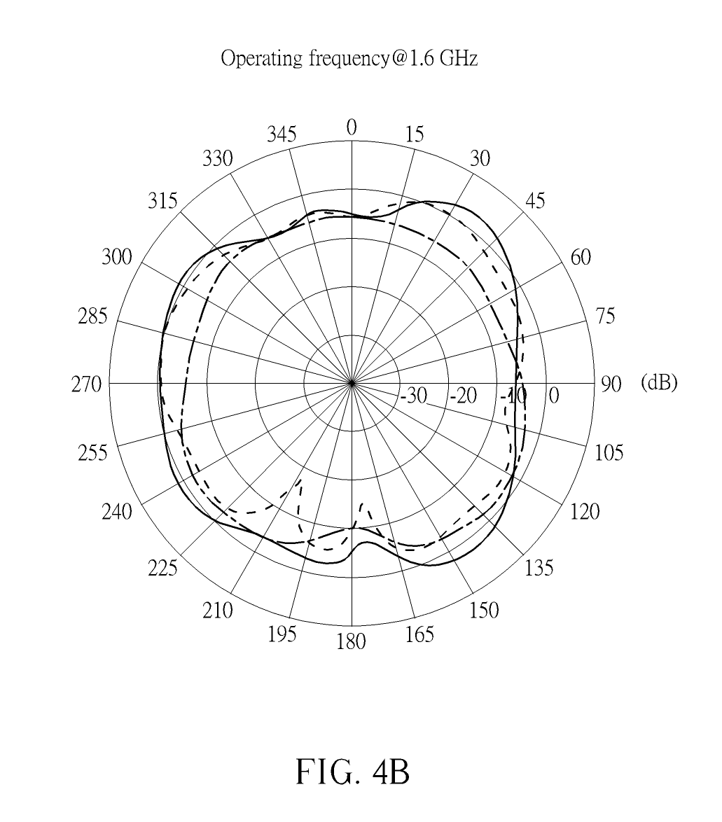

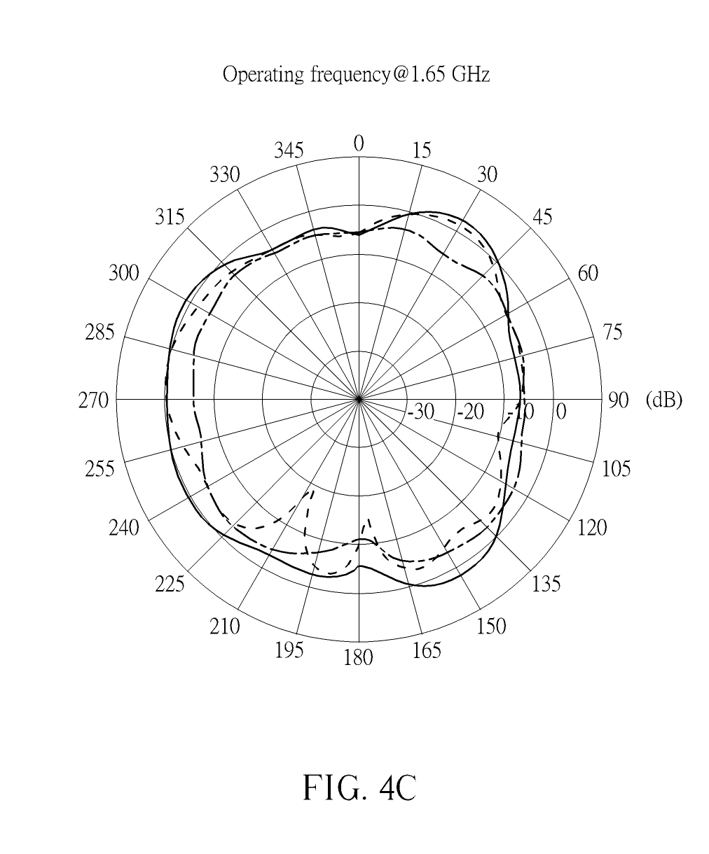

Please refer to FIG. 4A to FIG. 4C, Table 1 and Table 2. FIG. 4A to FIG. 4C are schematic diagrams illustrating radiation patterns of the mobile communication device 10 at operating frequencies 1.57 GHz, 1.6 GHz and 1.65 GHz, respectively. The radiation pattern in X-Y plane is denoted with a solid line, the radiation pattern in Y-Z plane is denoted with a dashed line, the radiation pattern in X-Z plane is denoted with a dotted and dashed line.

Table 1 illustrates radiation efficiencies of the mobile communication device 10 corresponding to Global Positioning System (GPS) band. Table 2 illustrates efficiencies of the mobile communication device 10 corresponding to Wi-Fi and Bluetooth bands. The mobile communication device 10 may utilize a co-axial cable as the transmission line 13.

TABLE 1
Global Positioning System frequency band

| | | | | |
|---|---|---|---|---|
| Frequency (GHz) | 1.55 | 1.575 | 1.6 | 1.65 |
| Efficiency (%) | 43.32 | 58.22 | 60.2 | 59.55 |

TABLE 2
Wi-Fi and Bluetooth frequency band

| | | | | | | | |
|---|---|---|---|---|---|---|---|
| Frequency (GHz) | 2.35 | 2.40 | 2.41 | 2.42 | 2.43 | 2.44 | 2.45 |
| Efficiency (%) | 47.83 | 60.44 | 53.86 | 54.08 | 54.75 | 53.76 | 55.91 |
| Frequency (GHz) | 2.46 | 2.47 | 2.48 | 2.49 | 2.50 | 2.55 | 2.6 |
| Efficiency (%) | 56.42 | 54.5 | 53.56 | 54.05 | 60.49 | 55.99 | 52.97 |

As can be seen from Table 1, Table 2 and FIG. 4A to FIG. 4C, the FPCB 12 may be able to integrated into the mobile communication device 10, in the global positioning system band, the Wi-Fi band and the Bluetooth band, radiation efficiencies of the FPCB 12 are around 50%. Therefore, the mobile communication device 10 may operate in the above mentioned bands.

To sum up, the FPCB has advantages such as being thin as a paper to save space, flexibility and customized production, so that the present invention designs an antenna on the FPCB to integrate a transmission line, i.e. the transmission unit 120, and an antenna, i.e. the radiation unit 122, into a single part, i.e. the FPCB 12, which may save cost and time for separately producing the transmission line and the antenna and may effectively make use of the interior space and the circuit design of the mobile communication as well.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile communication device, comprising:
a main board comprising:
a central process unit (CPU) disposed on the main board for outputting and receiving a control signal; and
a wireless transmitter disposed on the main board and coupled to the CPU for modulating and demodulating a wireless signal to the CPU to perform signal process;
a flexible printed circuit board (FPCB) coupled to the CPU to operate as an antenna for transmitting the control signal and radiating and receiving the wireless signal, the FPCB comprising:
a transmission unit coupled to the CPU for transmitting the control signal;
a radiation unit for radiating and receiving the wireless signal; and
a feed point formed on the radiation unit for feeding the wireless signal to the radiation unit; and
a transmission line coupled between the feed point and the wireless transmitter for transmitting the wireless signal.

2. The mobile communication device of claim 1, wherein the radiation unit of the FPCB is coupled to a ground unit of the main board, and the ground unit provides a system ground.

3. The mobile communication device of claim 2, wherein the FPCB operates as a Planar Inverted-F Antenna (PIFA).

4. The mobile communication device of claim 1, further comprising:
a housing;
a button formed on a surface of the housing and coupled to the FPCB for generating the control signal via being pressed by an external force, or for adjusting the control signal via being slid by the external force.

5. The mobile communication device of claim 1, further comprising a matching circuit disposed on the main board and coupled between the transmission line and the wireless transmitter for matching impedances between the transmission line and the wireless transmitter.

6. The mobile communication device of claim 1, further comprising a matching circuit disposed on the main board and coupled between the transmission line and the feed point for matching impedances between the transmission line and the wireless transmitter.

7. The mobile communication device of claim 1, wherein the transmission line is a co-axial cable, a metal wire, a pogo pin, a spring, a printed trace of the FPCB or a printed trace of the main board.
